(19) United States
(12) Patent Application Publication
(10) Pub. No.: US 2010/0327018 A1
(43) Pub. Date: Dec. 30, 2010

(54) LIQUID MIXING RESERVOIR

(75) Inventor: Paulus Antonius Augustinus Höfte, Astene (BE)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 12/823,396

(22) Filed: Jun. 25, 2010

(30) Foreign Application Priority Data
Jun. 30, 2009 (EP) 09164098.7

(51) Int. Cl. B67D 7/74; G01F 11/26; B65D 25/40

(52) U.S. Cl. 222/145.5; 222/456; 222/1; 222/500

(57) ABSTRACT

An apparatus and method for dispensing liquids and/or mixtures of liquids without contamination of starting liquids during the pouring operation, the apparatus comprising a mixing reservoir comprising a drain-back baffle.

### CROSS REFERENCE TO RELATED APPLICATION

This application claims priority under 35 U.S.C. §119(a) to European Application Serial No. 09164098.7, filed Jun. 30, 2009.

### FIELD OF THE INVENTION

The present invention relates to an apparatus and method for dispensing liquids and/or mixtures of liquids without contamination of starting liquids during the pouring operation.

### BACKGROUND TO THE INVENTION

There exist apparatus that allow late stage, in-the-home customization of liquid products by the consumer. Customization usually involves the addition of one or more optional ingredients to a base composition resulting in a product optimized for the particular preference of each consumer.

EP1760142A1 discloses a number of ways of achieving late stage scent customization of laundry products. Many of these involve the consumer mixing at least two liquids in a receptacle prior to the resultant mixture being used in the intended application, such as a laundry machine. Thus, the consumer requires at least three separate articles in order to achieve the customization; the first liquid in a container, the second liquid in a container and the mixing receptacle. There are then a number of steps required to be completed by the consumer; addition of the first liquid to the mixing receptacle, addition of the second liquid to the mixing receptacle and dispensing of the resultant mixture from the mixing receptacle to the end use application. This process is time consuming and requires for efficient use, the consumer to store the three separate articles together which is space consuming.

A preferred method of mixing the two liquids is also disclosed in EP1760142A1. A bottle is provided comprising a chamber in which there is a neutral scented base liquid laundry detergent composition. Integrated into the bottle is a dosing chamber which the neutral scented base liquid laundry detergent composition can flow through upon dispensing the liquid during pouring. A scent disc can also be connected to the dosing chamber. The consumer can then dose a volume of the scent disc liquid into the dosing chamber. Then upon pouring, the neutral scented base liquid laundry detergent composition flows through the dosing chamber, mixing with the scent liquid before it is dispensed out of the bottle. This then has the benefit of allowing the consumer to store the apparatus as a single unit, and also involves a much simpler mixing and dispensing process.

However, there are problems with this apparatus. A first issue is that once the mixture has been dispensed out of the bottle during pouring, there is a tendency for a small volume to remain in the dosing chamber. There is then a risk that this small volume can contaminate the neutral scented base liquid laundry detergent composition as the bottle is returned to an upright position following pouring due to the neutral scented base liquid laundry detergent composition flowing back from the dosing chamber into the neutral scented base liquid laundry detergent composition storage chamber. A second issue is that the dosing chamber is integrated into the bottle. Therefore, there is not the option to change/renew the neutral scented base liquid laundry detergent composition, only the scent disc. Therefore, in order to change/renew the neutral scented base liquid laundry detergent composition, a new dosing chamber must also be supplied. This is cost inefficient and environmentally unsound as the old dosing chamber will be thrown out.

Therefore, in the context of consumer in-the-house customization there exists in the art the need for an apparatus for dispensing via pouring, a liquid which are in contact with one another, which does not suffer from contamination of the starting liquid(s) during the pouring process. There is a further need to prevent liquid added to the mixing reservoir from overflowing from it, when too much of the liquid is inadvertently added. There is also a need that the starting liquids are preferably changeable and renewable.

The present invention provides an apparatus for dispensing a liquid comprising a mixing reservoir which comprises a drain-back baffle. The drain-back baffle prevents the contamination of the starting liquids during the pouring process. It also helps prevent liquids from overflowing out from the mixing reservoir during their addition to the mixing reservoir. It also allows for the removable attachment of a container containing a liquid. The present invention also provides an apparatus for mixing at least two liquids and dispensing the at least two liquids and/or a mixture of the at least two liquids comprising a mixing reservoir which comprises a drain-back baffle.

### SUMMARY OF THE INVENTION

A first aspect of the present invention is an apparatus (1) for mixing and dispensing liquids comprising a mixing reservoir (2); wherein, the mixing reservoir (2) comprises a drain-back baffle (3);

and a first end of a liquid flow channels communicates with the mixing reservoir (2);
and a first container (5) comprising an opening (6), communicates with a second end of the liquid flow channel (4), and wherein the first container contains a first liquid (7);
and wherein a dispensing outlet (8) communicates with the mixing reservoir (2);
and an additional liquid inlet opening (9) communicates with the mixing reservoir (2);
wherein an additional liquid contained in a second container can flow into the mixing reservoir (2) through the additional liquid inlet (9) when the apparatus (1) is in a standing position;
and upon tilting the apparatus (1);
the first liquid (7) flows into the mixing reservoir (2) through the liquid flow channel (4) and the first liquid (7) and/or an additional liquid and/or a mixture of the first liquid (7) and the additional liquid can be dispensed through the dispensing outlet (8) from the mixing reservoir (2);
wherein the mixing reservoir (2) comprises at least a first side (10), a second side (11), and the drain-back baffle (3), wherein the first side (10) and the second side (11) form the basin of the a mixing reservoir (2), and wherein the second side (11) comprises the drain-back baffle (3) and wherein the drain-back baffle is positioned at an angle from 30° to 90°, preferably from 40° to 80° relative to the first side (10).

A second aspect of the present invention is a method for mixing and dispensing a first liquid 7 and/or an additional liquid and/or a mixture of the first liquid 7 and the additional liquid from an apparatus 1 described in any preceding claims, comprising the steps of;
Dispensing from a second container, an additional liquid into the mixing reservoir 2 through the additional liquid inlet opening 9;
Tilting the apparatus 1 at an angle such that the first liquid 7 flows from the first container 5 into the mixing reservoir 2 comprising the drain-back baffle 3;
Maintaining the tilting angle such that, a desired volume of the first liquid 7 and/or the additional liquid and/or a mixture of the first liquid 7 and the additional liquid is dispensed out of the dispensing outlet 8;
Decreasing the tilting angle to prevent any further liquid from being dispensed from the apparatus 1;
Further decreasing the tilting angle to return the apparatus 1 to the resting position.

### BRIEF DESCRIPTION OF THE DRAWINGS

FIGS. 1A and B show the apparatus of the present invention comprising the mixing reservoir 2 comprising a drain-back baffle 3; a liquid flow channel 4, a first container 5 comprising an opening 6 into the liquid flow channel 4, and a first liquid 7, a dispensing outlet 8.

FIG. 2 depicts another embodiment of the present invention wherein, the mixing reservoir 2 comprising the drain-back baffle 3 is manufactured as a single unit and placed into the first container opening 6.

FIGS. 3A-C depict the pouring operation of the present invention.

FIGS. 4A and B depict the angles of the drain-back baffle 3 relative to the first side 10 of the mixing reservoir 2.

FIGS. 5A and B depict another embodiment of the present invention, wherein the apparatus 1 further comprises a cap.

### DETAILED DESCRIPTION OF THE INVENTION

By “removably attached” we herein mean the first container is attached in place but not necessarily in a permanent manner. It should be understood that it is the intention that the first container is sufficiently secured in place such that a particular operation of the apparatus 1 may be achieved, but can be unattached from the apparatus 1 and replaced.

By “baffle” we herein mean a suitable means to restrain the flow of a liquid. By the terms “a” and “an” when describing a particular element, we herein mean “at least one” of that particular element.

### The Apparatus

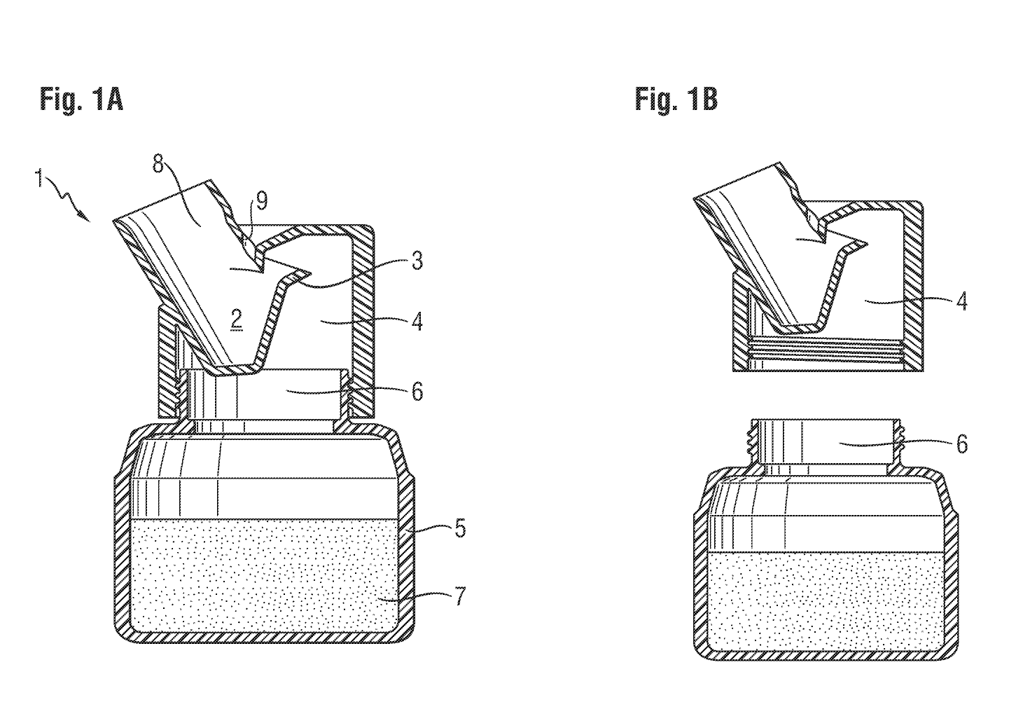

FIGS. 1A and 1B detail the apparatus 1 of the present invention. The apparatus 1 comprises a mixing reservoir 2, the mixing reservoir 2 comprising a drain-back baffle 3. A liquid flow channel 4, having a first end, communicates with the mixing reservoir 2. A first container 5 having an opening 6 communicates with a second end of the liquid flow channel 4, and contains a first liquid 7. A dispensing outlet 8 communicates with the mixing reservoir 2, and also an additional liquid inlet opening 9 communicates with the mixing reservoir 2. An additional liquid contained in a second container can flow into the mixing reservoir 2 through the dispensing outlet 8, when the apparatus 1 is in a standing position. Then, upon tilting the apparatus 1, the first liquid 7 flows into the mixing reservoir 2 through the liquid flow channel 4 and the first liquid 7 and/or an additional liquid and/or a mixture of the first liquid 7 and the additional liquid can be dispensed through the dispensing outlet 8 from the mixing reservoir 2.

The additional liquid inlet opening 9 is positioned such that at least a second liquid can be dispensed into the mixing reservoir 2, and not into the liquid flow channel 4. In a preferred embodiment, there are two additional liquid inlet openings, more preferably three additional liquid inlet openings, all positioned such that the second, third or fourth liquid can be dispensed into the mixing reservoir 2, and not into the liquid flow channel 4. The additional liquid inlet 9 is also preferably positioned in such a way that any liquid being dispensed out of the dispensing outlet 8 cannot flow into the additional liquid inlet 9. This is most effectively achieved by positioning the additional liquid inlet 9 above the mixing reservoir 2. Those skilled in the art will recognize suitable positioning locations to ensure this. In a preferred embodiment, the additional liquid inlet opening 9 also comprises a channel or spout, which directs any additional liquid into the mixing reservoir 2, and not into the liquid flow channel 4.

The liquid flow channel 4 is positioned so as to direct the first liquid 7 from the first container 5 into the mixing reservoir 2 during the pouring operation. Those skilled in the art will recognize suitable arrangements of the liquid flow channel 4 to achieve this.

The apparatus 1 can be made from any suitable thermoplastic polymer resin. Preferably, the thermoplastic polymer resin is selected from the group comprising polyethylene, polypropylene, polyethylene terephthalate, or copolymers thereof, and mixtures thereof.

In one embodiment, the mixing reservoir 2 comprising the drain-back baffle 3, the liquid flow channel 4, the dispensing channel 8, and the first container 5 are manufactured as a single unit. In another embodiment, the mixing reservoir 2 comprising the drain-back baffle 3, the liquid flow channel 4, and the dispensing outlet 8 are manufactured as a single unit, and separately, the first container 5 is manufactured as a single unit. In another embodiment the mixing reservoir 2 comprising the drain-back baffle 3 is manufactured as a single unit and placed into the first container opening 6. The mixing reservoir 2 comprising the drain-back baffle 3 could in one embodiment be removably secured to the first container opening, or in another embodiment, it could be manufactured as a non-removable aspect of the first container 5. In this embodiment, dispensing outlet 8, and a liquid flow channel 4 are manufactured as a single unit, wherein the first container opening 6 comprising the mixing reservoir 2 is removably secured to the liquid flow channel 4, forming the complete apparatus 1. In yet another embodiment, the mixing reservoir 2 comprising the drain-back baffle 3 and the first container 5 are manufactured as a single unit. Again, in this embodiment, dispensing outlet 8, and a liquid flow channel 4 are manufactured as a single unit, wherein the first container opening 6 comprising the mixing reservoir 2 is removably secured to the liquid flow channel 4, forming the complete apparatus 1.

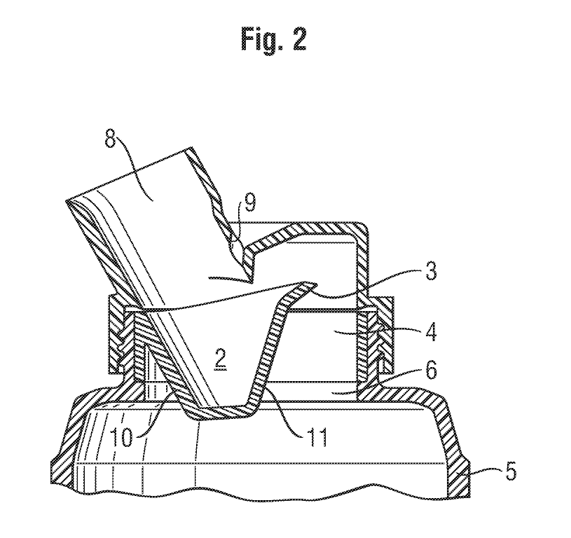

In one embodiment, the mixing reservoir 2 comprising the drain-back baffle 3, the liquid flow channel 4, the additional liquid inlet 9, the dispensing outlet 8, and the first container 5 are manufactured as a single unit. In another embodiment, the mixing reservoir 2 comprising the drain-back baffle 3, the liquid flow channel 4, the additional liquid inlet 9 and the dispensing outlet 8 are manufactured as a single unit, and the first container 5 is manufactured as a single unit. Preferably, the first container opening 6 is removably secured to the liquid flow channel 4 forming the complete apparatus 1 as depicted in FIGS. 1A and 1B. FIG. 2 depicts another embodiment wherein, the mixing reservoir 2 comprising the drain-back baffle 3 is manufactured as a single unit and placed into the first container opening 6. The mixing reservoir 2 comprising the drain-back baffle 3 could in one embodiment be removably secured to the first container opening, or in another embodiment, it could be manufactured as a non-removable aspect of the first container 5. In this embodiment, dispensing outlet 8, additional liquid inlet 9 and liquid flow channel 4 are manufactured as a single unit, wherein the first container opening 6 comprising the mixing reservoir 2 is removably secured to the liquid flow channel 4, forming the complete apparatus 1. In yet another embodiment, the mixing reservoir 2 comprising the drain-back baffle 3 and the first container 5 are manufactured as a single unit. Again, in this embodiment, dispensing outlet 8, additional liquid inlet 9 and liquid flow channel 4 are manufactured as a single unit, wherein the first container opening 6 comprising the mixing reservoir 2 is removably secured to the liquid flow channel 4, forming the complete apparatus 1.

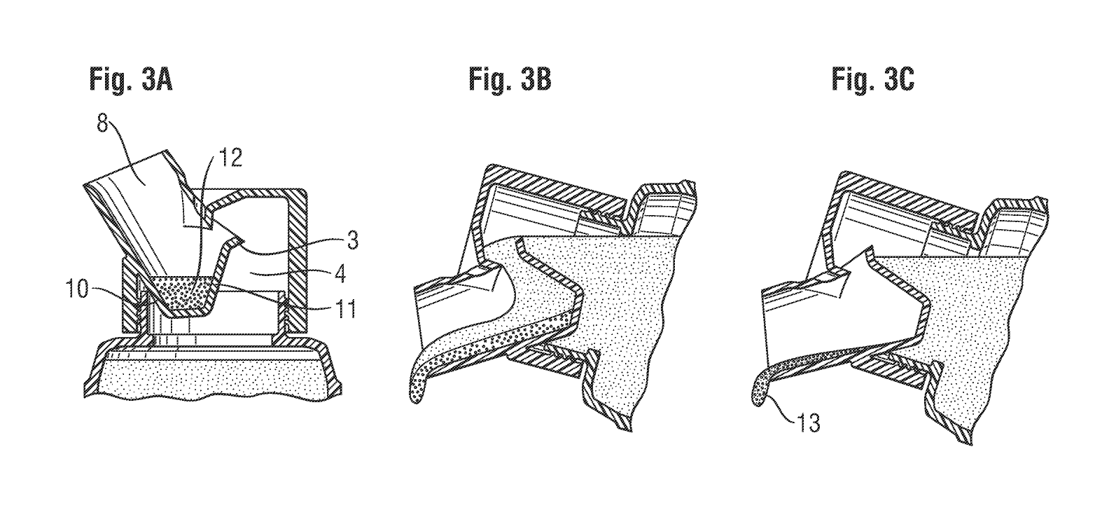

The mixing reservoir 2 comprises a drain-back baffle 3. The drain-back baffle 3 is designed to prevent any liquid present in the mixing reservoir 2 from flowing back into the liquid flow channel 4 during the pouring operation and subsequently into the first liquid 7. As shown in FIGS. 3A-C, the mixing reservoir 2 comprises at least a first side 10, a second side 11, wherein preferably the first side 10 and the second side 11 form the basin of the mixing reservoir 2. Those skilled in the art will recognize suitable shapes and configurations for the basin of the mixing reservoir 2. The second side 11 comprises the drain-back baffle 3. One or more additional liquids 12 can be dispensed into the mixing reservoir 2 as depicted in FIG. 3A through the additional liquid inlet 9. In the apparatus 1 resting position as depicted in FIG. 3A, the additional liquid 12 is separate from the first liquid 7, which is situated in the first container 5. As depicted in FIG. 3B, in order to mix and dispense the first liquid 7 and the additional liquid 12, the apparatus 1 is tilted by the user such that the first liquid 7 flows along the liquid pouring channel 4, over the drain-back baffle 3 and into the mixing reservoir 2, where it can mix with the additional liquid 12 and then the first liquid 7, and additional liquid 12 flow out of the dispensing outlet 8. Following dispensing of a desired volume of liquid, the apparatus 1 is returned to the resting position by the consumer. During the operation of returning the apparatus 1 to the resting position, as the apparatus is tilted closer to the resting position, the drain-back baffle 3 prevents any further volume of the first liquid 7 from flowing into the mixing reservoir 2.

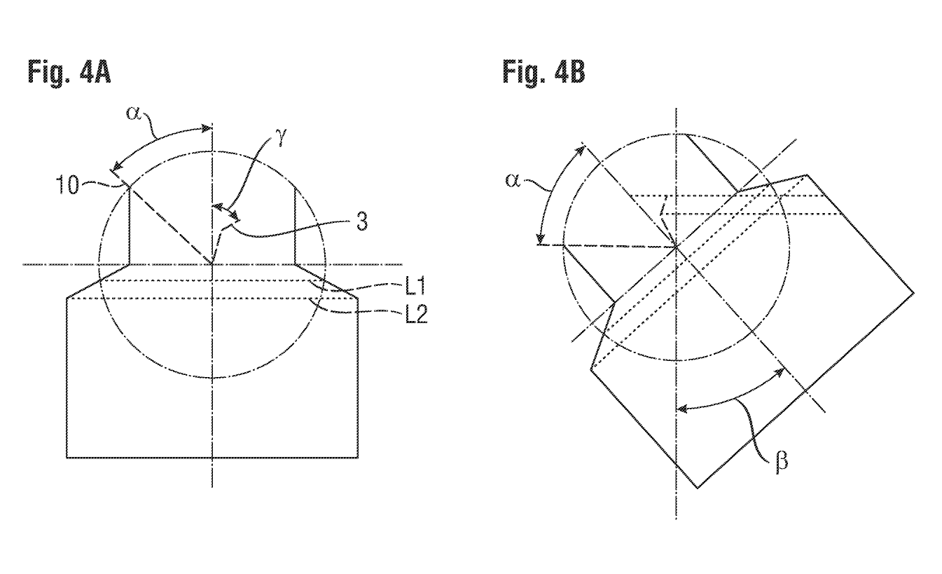

The drain-back baffle 3 has to be at angle of between 30° and 90° relative to the first side 10 of the mixing reservoir 2. In another embodiment, the drain-back baffle 3 has to be at angle of at least 60° relative to the first side 10 of the mixing reservoir 2. As depicted in FIG. 4A, the angle between the first side 10 and the vertical axis is α. The angle between the drain-back baffle 3 and the vertical axis is γ. L1 and L2 represent two varying levels of the first liquid 7. As depicted in FIG. 4B, as the apparatus 1 is tilted, the tilting angle β (measured as the angle between the vertical axis and the vertical centre-line of the apparatus) increases. In order for liquid to flow from the first container 5 in to the mixing reservoir 2 and out of the a dispensing outlet 8, the sum of α+β must equal at least 90°. Preferably, it is at least 91° as this will allow any liquid still in the a mixing reservoir 2 to flow out of the dispensing outlet 8, when the liquid level of the first liquid 7 is such that is prevented from flowing into the mixing reservoir 2 by the drain-back baffle 3 at a given angle β.

As seen in FIG. 4B, upon pouring, the liquid level L1 decreases to L2. In order to prevent any more liquid from flowing into the mixing reservoir 2, at the tilting angle β when the liquid level is at L2, the angle between the drain-back baffle 3 and the first side 10 must be at least 30°. Thus the sum of α+γ must equal at least 30°. In order to prevent liquid from being trapped behind the drain-back baffle 3, the sum of α+γ must equal maximum 90°. Therefore, the angle between the drain-back baffle 3 and the first side 10 of the mixing reservoir is from 30° to 90°, preferably from 40° to 80°. Those skilled in the art will recognize suitable tilting angles β to allow the operation of the apparatus 1 at various angles of α and γ.

The dispensing outlet 8 must be positioned so as to allow the liquid to flow directly from the mixing reservoir 2 along the first side 10 and out of the apparatus during the pouring operation. Those skilled in that art will recognize suitable locations and dimensions for the dispensing outlet 8 so as to achieve this.

To ensure the liquid in the a mixing reservoir 2 empties from the a mixing reservoir 2 when the flow of the at least first liquid 7 is blocked by the drain-back baffle 3, the angle α is preferably from 10° to 80° more preferably 20° to 70° more preferably 30° to 60°.

In one embodiment, the baffle is at the same angle to the first side 10 as the second side 11 is to the first side 10.

In one embodiment, the dispensing outlet 8 comprises a pouring spout, or channel. The pouring spout or channel can be of any suitable length or shape as recognized by those skilled in the art. In a preferred embodiment, the spout is at the same angle as the first side 10 of the mixing reservoir 2 to that of the second side 11. In a preferred embodiment, the spout is at an angle relative to the second side 11 greater than the angle of the first side 10 relative to the second side 11. This is preferable for ensuring all liquid is dispensed from the dispensing outlet spout during the pouring operation.

The drain-back baffle 3 may also comprise other additional elements such as a curved lip to aid the flow of liquid from the liquid flow channel 4 into the mixing reservoir 2. In one embodiment, the drain-back baffle 3 may further comprise a one-way valve means. In one embodiment, the drain-back baffle 3 may further comprise a hinged one-way valve arrangement. The valve is arranged so as to close off the liquid flow channel 4. Upon tilting the bottle, the first liquid 8 will enter the liquid flow channel 4, through the hinged one-way valve arrangement and into the mixing reservoir 2. Upon returning the apparatus 1 to the resting position, the hinged one-way valve closes off the liquid flow channel 4 from the mixing reservoir 2. In a further embodiment, the one-way valve is a duckbill valve. Most preferably the one-way duckbill valve should be formed with a material having positional memory. Preferably, suitable materials for the manufacture of the one-way duckbill valve are selected from the group comprising polyethylene, polypropylene, polyoxymethylene plastic (available commercially as Delrin™), thermoplastic elastomer, liquid silicon rubber, thermoplastic urethane, acrylonitrile butadiene rubber, nytril rubber, natural rubber, ethylene propylene diene monomer rubber or similar materials or mixtures or copolymers of these materials. In one embodiment, the one-way duckbill valve is manufactured from a thermoplastic elastomer, preferably selected from the group comprising styrenic block copolymers, polyolefin blends, elastomeric alloys, thermoplastic polyurethanes, thermoplastic copolyester and thermoplastic polyamides or mixtures thereof. Preferred examples of commercially available thermoplastic elastomers include Santoprene™, poly(p-phenylene oxide), Elastolan™ and Hytrel™. Preferably, the one-way duckbill valve is manufactured from a material selected from the group comprising polyethylene, polypropylene or mixtures thereof. In one embodiment, the one-way duckbill valve is manufactured from polyethylene. In another embodiment, the one-way duckbill valve is manufactured from polypropylene.

The first liquid 7 can be any liquid. Preferably it is selected from the group comprising, cleaning composition, laundry detergent, fabric softening composition, fabric care composition, cosmetic composition, shampoo, hair conditioning composition, body cleansing composition, hard surface cleaner, bleaching composition and mixtures thereof.

In a preferred embodiment, it is a fabric softening composition.

The first container 5 can be of any shape, providing the opening 6 can correspond to the liquid flow channel 4. Preferably, the first container opening 6 is removably secured to the liquid flow channel 4 via a method selected from the group comprising screwing, clipping, clamping, gripping, snapping, pressure fitting and combinations thereof. Preferably, the method of removably securing the first container opening 6 to the liquid flow channel 4 provides a liquid tight seal, so that no liquid can leak during the pouring operation of the apparatus 1.

An additional liquid can be dispensed through the additional liquid inlet opening 9. In a preferred embodiment, there are two additional liquid inlet openings, more preferably three additional liquid inlet openings. In a preferred embodiment, a first additional liquid is supplied in a second container, wherein preferably, the second container can be removably secured to the apparatus 1 such that the first additional liquid can be dispensed into the a mixing reservoir 2 via the additional liquid inlet opening 9. In a more preferred embodiment, a first additional liquid is supplied in a second container, a second additional liquid is supplied in a third container and a third additional liquid is supplied in a fourth container. In this more preferred embodiment, the apparatus 1 comprises three additional liquid inlet openings positioned such that any additional liquid dispensed through the three additional liquid inlet openings flows into the mixing reservoir 2 and not the liquid flow channel 4. Preferably, the second, third and fourth containers can be removably secured to the apparatus 1, such that the opening of the second container corresponds to the first additional liquid inlet opening, the opening of the third container corresponds to the second additional liquid inlet opening, the opening of the fourth container corresponds to the third liquid inlet opening, and mixtures thereof. This then allows for the addition of up to three different additional liquids into the mixing reservoir 2. In another embodiment, the three additional liquid inlet openings each comprise a channel or spout to direct any liquid dispensed through the additional liquid inlet channels into the mixing reservoir 2. These three channels or spouts may or may not converge so as to form a single channel or spout for dispensing liquid into the mixing reservoir 2. In one embodiment, the mixing reservoir 2 comprises sections, so that each additional liquid is kept separate when dispensed into the mixing reservoir 2. In another embodiment, the apparatus 1 comprises additional mixing reservoirs 2 such that each additional liquid is dispensed into a separate mixing reservoir 2.

Suitable additional containers containing the additional liquids are preferably selected from the group comprising, bottle, cartridge, bag in bottle, delaminating bottles, delaminating cartridges, squeeze tubes, bag in tube, aerosol can, pouch, pouches with dispensing buttons, bellows, flexible bladder, dropper, pipette, capsule, sack, bag, disc, vessel, container, canister, blister, receptacle, holder, syringes or simple pump mechanisms using a piston to displace the product and other dosing systems known in the art and combinations thereof. The additional containers may be removably secured to the apparatus 1 using any suitable means, preferably selected from the group comprising screwing, clipping, clamping, gripping, snapping, pressure fitting and combinations thereof. Preferably, the additional containers comprise means to dispense a portion of liquid. More preferably, they comprise further means to prevent unintended leakage of the additional liquid into the mixing reservoir 2.

Preferably, the second (and subsequent additional containers), is a cartridge comprising an inner chamber comprising a volume of an additional liquid, a button which upon being pressed will change shape and reduce the overall volume of the inner chamber (4), but upon release will return to its original shape, increasing the volume of the inner chamber (4) to its original volume, a spring element and a one-way valve. The apparatus 1 further comprises a cartridge mating member comprising a one-way valve engagement pin, a spring element interaction surface and an opening. The user presses the button. This action depresses button and pushes the cartridge against the cartridge mating member. This compresses the spring element against the spring element interaction surface, which brings the one-way valve into contact with the one-way valve engagement pin, opening the one-way valve.

The additional liquid contained in the additional containers can be dispensed from the additional containers to the additional liquid inlet opening 9 using any other suitable means, preferably selected from the group comprising, pumping, injecting, syringing, squeezing, spraying, pouring, dripping, capillary action and combinations thereof

The additional liquid can be any liquid. The term ‘additional liquid’ as used herein is not meant to be a limiting term and may encompass emulsions, dispersions, compositions, suspensions, pastes, gels and the like or mixtures thereof. The additional liquid is preferably an additive suitable for use in the group comprising fabric care, hair care and body, detergents/cleaners, dish care and the like.

Preferably, the additional liquid is selected from the group comprising perfume composition, encapsulated perfume composition, pro-perfume composition or combinations thereof. In a preferred embodiment, the additional liquid is a perfume composition.

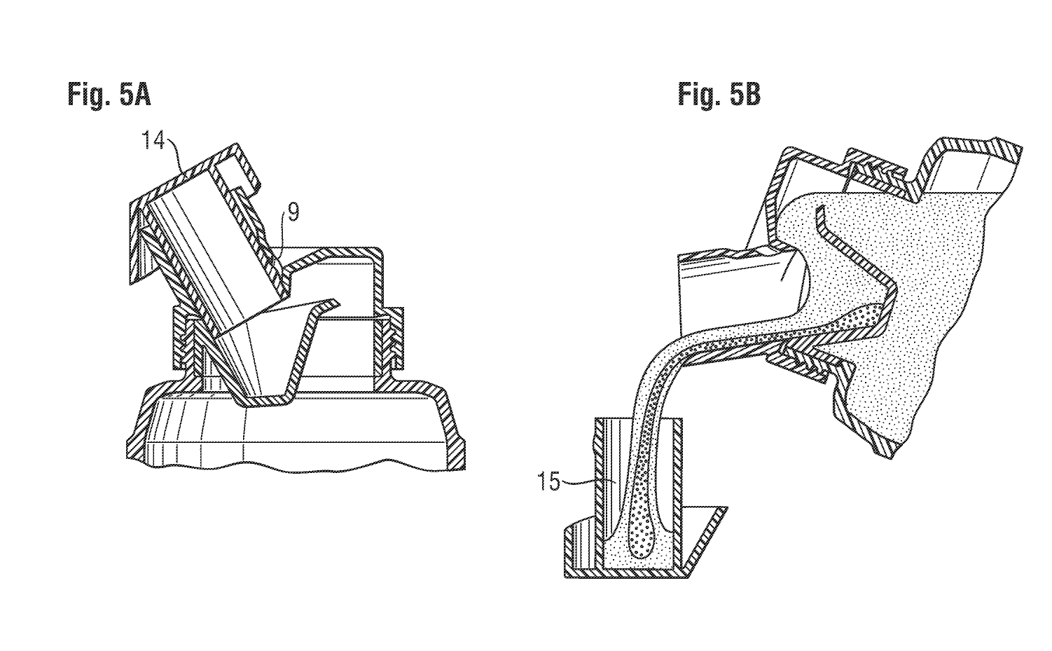

In one embodiment, the apparatus 1 is supplied with a cap 14 which fits into the dispensing outlet 8, depicted in FIGS. 5A and B. The cap is preferably selected from the group comprising regular cap, dosing cap, snap-on cap, screw-on cap, twist to dose cap. Preferably, the cap 14 comprises a chamber 15. During storage or shipping the apparatus 1 may be dropped, knocked over and the like. In certain circumstances, the apparatus 1 could be in a position such that the first liquid 7 could flow through the liquid flow channel 4 and out of the dispensing outlet 8. This would then result in unwanted spillage of the first liquid 7. In another scenario, the apparatus 1 may be positioned such that the first liquid 7 is able to flow through the additional liquid inlet opening 9 and either contaminate an additional liquid or flow out of the apparatus 1 and cause unwanted spillage. The cap 14 may serve two purposes. Firstly, when fitted into the dispensing outlet 8, the cap 14 blocks the dispensing outlet 8. In another embodiment it blocks the dispensing outlet 8 and also the additional liquid inlet opening 9. Other additional elements can be fitted to the cap to ensure a snug fit and also to ensure the additional liquid inlet opening 9 is fully blocked off. The cap 14 can also serve as a measuring device, as depicted in FIG. 5B to ensure an appropriate volume of liquid is dispensed for the particular application. The dispensed liquid is measured into the cap chamber 15 and can then be dispensed from the cap chamber 15 into the desired end-use application. The cap can be manufactured from any suitable material, preferably from thermoplastic polymer resins. Most preferable, the thermoplastic polymer resin is selected from the group comprising polyethylene, polypropylene, polyethylene terephthalate, or copolymers thereof and mixtures thereof. In another embodiment, the cap is simply a seal which blocks the dispensing outlet 8. This seal can be removable and so prevents spillage of the first liquid 7 during the shipping operation of the product.

In another embodiment, the dispensing outlet 8 further comprises a one-way valve means. In one embodiment, the valve is a hinged valve arrangement which seals off the dispensing outlet 8. It is opened by the flow of liquid from the mixing reservoir 2 during the pouring operation. In an alternative embodiment, the dispensing outlet one-way valve is a duckbill valve. Most preferably the dispensing outlet duckbill valve should be formed with a material having positional memory. Preferably, suitable materials for the manufacture of the dispensing outlet duckbill valve are selected from the group comprising polyethylene, polypropylene, polyoxymethylene plastic (available commercially as Delrin™), thermoplastic elastomer, liquid silicon rubber, thermoplastic urethane, acrylonitrile butadiene rubber, nytril rubber, natural rubber, ethylene propylene diene monomer rubber or similar materials or mixtures or copolymers of these materials. In one embodiment, the dispensing outlet duckbill valve is manufactured from a thermoplastic elastomer, preferably selected from the group comprising styrenic block copolymers, polyolefin blends, elastomeric alloys, thermoplastic polyurethanes, thermoplastic copolyester and thermoplastic polyamides or mixtures thereof. Preferred examples of commercially available thermoplastic elastomers include Santoprene™, polyp-phenylene oxide), Elastolan™ and Hytrel™. Preferably, the dispensing outlet duckbill valve is manufactured from a material selected from the group comprising polyethylene, polypropylene or mixtures thereof. In one embodiment, the dispensing outlet duckbill valve is manufactured from polyethylene. In another embodiment, the dispensing outlet duckbill valve is manufactured from polypropylene.

### Mode of Operation

Another aspect of the present invention is a method for mixing and dispensing a first liquid 7 and/or additional liquid 12 and/or a mixture of the first liquid 7 and the additional liquid from an apparatus described in the first aspect, comprising the steps of
Dispensing from a second container, an additional liquid 12 into the mixing reservoir 2, through the additional liquid inlet opening 9;
Tilting the apparatus 1 at an angle such that the first liquid 7 flows from the first container 5 into the mixing reservoir 2 comprising the drain-back baffle 3;
Maintaining the tilting angle such that, a desired volume of the first liquid 7 and/or the additional liquid 12 and/or a mixture of the first liquid 7 and the additional liquid is dispensed out of the dispensing outlet 8;
Decreasing the tilting angle to prevent any further liquid from being dispensed from the apparatus 1;
Further decreasing the tilting angle to return the apparatus 1 to the resting position.

It would be obvious to those skilled in the art what tilting angle is necessary, in order to achieve the desired effect of dispensing the first liquid 8 and the additional liquid 12.

### Kit for Use

In one embodiment, the present invention provides a kit comprising, an apparatus 1 comprising, a mixing reservoir 2 comprising a drain-back baffle 3, a liquid flow channel 4, optionally an additional liquid inlet opening 9, a first container 5 comprising an opening 6, containing a first liquid 7, a dispensing outlet 8, and at least a second container comprising an additional liquid 12. Preferably, the first container 5 can be removably secured to the apparatus 1. Preferably, the at least second container can be removably secured to the apparatus 1. In a preferred embodiment, the kit comprises at a second container, more preferably a second and a third container, even more preferably at a second, a third and a fourth container. Preferably, the second, third and fourth containers can be removably secured to the apparatus 1. In a preferred embodiment, the kit is also provided with a cap 14 which fits into the dispensing outlet 8.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus (1) for mixing and dispensing liquids comprising a mixing reservoir (2);
wherein, the mixing reservoir (2) comprises a drain-back baffle (3);
and a first end of a liquid flow channels communicates with the mixing reservoir (2);
and a first container (5) comprising an opening (6), communicates with a second end of the liquid flow channel (4), and wherein the first container contains a first liquid (7);
and wherein a dispensing outlet (8) communicates with the mixing reservoir (2);
and an additional liquid inlet opening (9) communicates with the mixing reservoir (2);
wherein an additional liquid contained in a second container can flow into the mixing reservoir (2) through the additional liquid inlet (9) when the apparatus (1) is in a standing position;
and upon tilting the apparatus (1);
the first liquid (7) flows into the mixing reservoir (2) through the liquid flow channel (4) and the first liquid (7) and/or an additional liquid and/or a mixture of the first liquid (7) and the additional liquid can be dispensed through the dispensing outlet (8) from the mixing reservoir (2);
wherein the mixing reservoir (2) comprises at least a first side (10), a second side (11), and the drain-back baffle (3), wherein the first side (10) and the second side (11) form the basin of the a mixing reservoir (2), and wherein the second side (11) comprises the drain-back baffle (3) and wherein the drain-back baffle is positioned at an angle from about 30° to about 90° relative to the first side (10).

2. The apparatus of claim 1, wherein the drain-back baffle is positioned at an angle from about 40° to about 80° relative to the first side (10)

3. The apparatus of claim 1, comprising at least three additional liquid inlet openings.

4. The apparatus of claim 1, wherein the first container (5) is removable from the apparatus (1).

5. The apparatus of claim 1, wherein the apparatus (1) comprises a first container (5) comprising an opening (6) and second container comprising an second opening, preferably a first container comprising an opening, a second container comprising a second opening and a third container comprising a third opening, more preferably a first container comprising an opening, a second container comprising a second opening, a third container comprising a third opening and a fourth container comprising a fourth opening.

6. The apparatus of claim 5, wherein the containers are removable from the apparatus (1).

7. The apparatus of claim 1, wherein a cap (14) fits into the dispensing outlet (8) and blocks the flow of liquid into and out of the additional liquid inlet opening (9).

8. The apparatus of claim 1, wherein the dispensing outlet (8) comprises a pouring spout.

9. The apparatus (1) of claim 8, wherein the pouring spout is at an angle relative to the second side (11) of the mixing reservoir (2) greater than the angle of the first side (10) of the mixing reservoir (2) relative to the second side (11) of the mixing reservoir (2).

10. The apparatus (1) of claim 1, wherein the dispensing outlet (8) further comprises a one-way valve means.

11. The apparatus (1) of any claim 1, wherein the drain-back baffle (3) further comprises a one-way valve means.

12. A method for mixing and dispensing a first liquid (7) and/or an additional liquid and/or a mixture of the first liquid (7) and the additional liquid from an apparatus (1) described in claim 1, comprising the steps of;
Dispensing from a second container, an additional liquid into the mixing reservoir (2) through the additional liquid inlet opening (9);
Tilting the apparatus (1) at an angle such that the first liquid (7) flows from the first container (5) into the mixing reservoir (2) comprising the drain-back baffle (3);
Maintaining the tilting angle such that, a desired volume of the first liquid (7) and/or the additional liquid and/or a mixture of the first liquid (7) and the additional liquid is dispensed out of the dispensing outlet (8);
Decreasing the tilting angle to prevent any further liquid from being dispensed from the apparatus (1);
Further decreasing the tilting angle to return the apparatus (1) to the resting position.

13. The method of claim 12 further comprising the step of decreasing the tilting angle to prevent any more of the first liquid (7) from flowing into the mixing reservoir (2), but still allowing any remaining first liquid and/or additional liquid in the mixing reservoir (2) to be dispensed out of the dispensing outlet (8).
